(19) United States
(12) Patent Application Publication
(10) Pub. No.: US 2011/0131514 A1
(43) Pub. Date: Jun. 2, 2011

(54) POLICY BASED ELECTRONIC CALENDAR MANAGEMENT

(75) Inventors: William P. Alberth, JR., Prairie Grove, IL (US); Gary DeGregorio, Sleepy Hollow, IL (US)

(73) Assignee: MOTOROLA, INC., Schaumburg, IL (US)

(21) Appl. No.: 12/626,895

(22) Filed: Nov. 28, 2009

(51) Int. Cl. G06F 3/048

(52) U.S. Cl. 715/764

(57) ABSTRACT

A method and a system for managing an electronic calendar. The method can include, in a calendar management system linked to a decision management system, associating a first calendar event with at least a first decision. In the calendar management system, prioritization information pertaining to the first decision can be collected. The prioritization information can indicate a decision type for the first decision and a value at risk in the first decision. A first calendar entry corresponding to the first calendar event, as well as the prioritization information pertaining to the first decision, can be presented to a user via a display of an electronic system.

### BACKGROUND OF THE INVENTION

1. Field of the Invention

The present invention generally relates to electronic calendars and, more particularly, to managing electronic calendar entries.

2. Background of the Invention

Electronic calendars are commonly used on a variety of digital processing platforms, including personal computers and mobile communication devices (e.g., mobile telephones and personal digital assistants). In a typical electronic calendar, one or more times of day, days, weeks, months and/or years may be presented in a suitable format, for example as selectable blocks within a calendar view. Oftentimes the blocks corresponding to days and times of day are configured to receive and display calendar entries, which typically comprise alphanumeric text. These calendar entries can serve to remind users of various events that are scheduled, for instance meetings, teleconferences, and so on.

The calendar entries may be populated manually by a primary user of the device on which the electronic calendar is instantiated, or populated by another user having access to the electronic calendar. For instance, if a user has shared his calendar with another user, for example an administrative assistant, such user may be provided access to populate and modify the calendar entries. In other arrangements, calendar entries may be populated to the electronic calendar in response to the user accepting a calendar invitation received via e-mail.

Sometimes calendar entries may conflict. For example, a particular calendar entry may indicate that the user is scheduled to attend a meeting at 10:00 A.M., while another calendar entry indicates that the user is scheduled to participate in a teleconference at 10:30 A.M. If the first meeting lasts longer than thirty minutes, the user may miss the teleconference. Thus, it is generally incumbent upon the user to review his calendar entries to ensure that no potential conflicts exist, and to reschedule various calendar entries as may be necessary to resolve the conflicts. For example, the user may reschedule the teleconference to 1:30 P.M. Unfortunately, other users who are also scheduled to participate in the teleconference may have other obligations at the newly scheduled time, thereby creating additional conflicts. Resolving the various conflicts that may arise can be very time consuming for the various users, thus creating administrative inefficiencies.

### SUMMARY OF THE INVENTION

The present invention relates to a method and a system for managing an electronic calendar. The method can include, in a calendar management system linked to a decision management system, associating a first calendar event with at least a first decision. In the calendar management system, prioritization information pertaining to the first decision can be collected. The prioritization information can indicate a decision type for the first decision and a value at risk in the first decision. A first calendar entry corresponding to the first calendar event, as well as the prioritization information pertaining to the first decision, can be presented to a user via a display of an electronic system.

Yet another embodiment of the present invention can include a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a calendar management system that is useful for understanding the present invention;

FIG. 2 depicts an example of a decision network that is useful for understanding the present invention;

FIG. 3 is a flowchart presenting a method of managing an electronic calendar that is useful for understanding the present invention;

FIG. 4 is another flowchart presenting a method of managing an electronic calendar that is useful for understanding the present invention; and

FIG. 5 is an electronic system that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to a policy based calendar management system that automatically manages electronically calendared events which relate to decisions that are to be made. For example, the calendar management system can determine whether any calendaring conflicts are present. If a calendaring conflict is present which prevents at least one of the scheduled decision making participants from participating in the calendar event, the decision management system can automatically change, for all scheduled participants, that calendar entry or the conflicting calendar entry in order to resolve the conflict. For example, the calendar management system can select a substitute decision making participant to participate in a decision making process in lieu of the original decision making participant, or select a substitute decision to be made in lieu of the original decision. The decision management system also can automatically reschedule a calendar event. Further, the decision management system can update corresponding calendar entries to indicate changes to the calendar event.

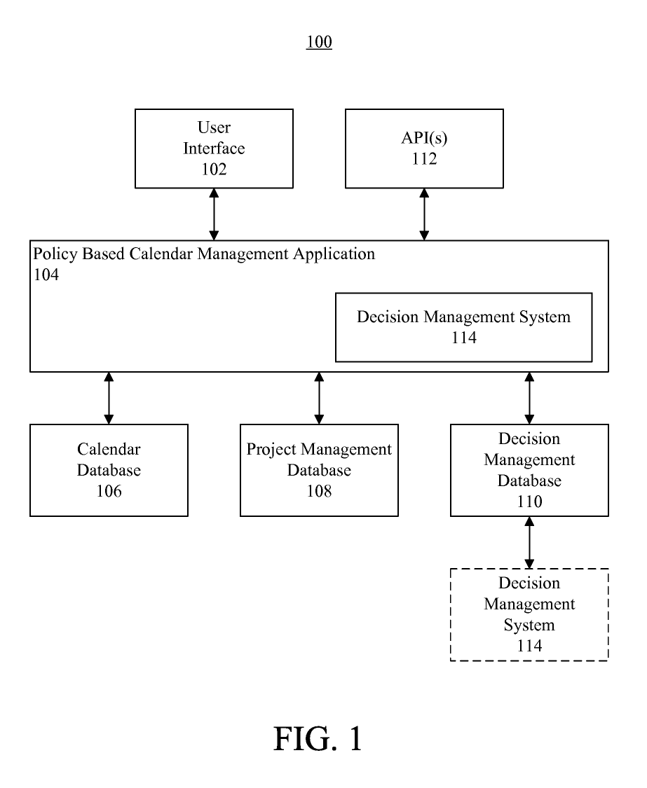

FIG. 1 depicts a calendar management system (hereinafter “CMS”) 100 that is useful for understanding the present invention. The CMS 100 can include a user interface 102. The user interface 102 can comprise one or more input devices suitable for receiving user inputs and communicating the user inputs to the policy based calendar management application. For example, the user interface 102 can include computer-usable program code that receives input signals from one or more tactile input devices (e.g., buttons, keys, softkeys, etc.), one or more audio input devices, or the like. The user interface 102 also can include computer-usable program code that communicates to one or more output devices information that is to be presented to one or more users. For example, the user interface 102 can communicate information to a graphics processing system for presentation on a display, to a speech synthesis application to be audibly presented, or the like.

The CMS 100 can include a policy based calendar management application (hereinafter “calendar management application”) 104. The calendar management application 104 can be implemented as a stand-alone application, implemented as an additional feature to an existing calendaring application, or implemented in any other suitable manner.

The CMS 100 also can include one or more databases or other decision management structures to which the calendar management application 104 is communicatively linked. For simplicity, hereinafter any suitable data management structures will be referred to as “databases.” Nonetheless, those skilled in the art will appreciate that the databases can include any number of data structures (e.g., data tables), and these data structures need not be maintained on the same processing device. Further, data can be entered into the database(s) by a user who is interacting with the user interface 102, or by an application configured to enter such decisions into the database(s). By way of example, the calendar management application 104 can be communicatively linked to a calendar database 106, a project management database 108 and a decision management database 110. Still, the calendar management application 104 can be communicatively linked with any other desired databases and the invention is not limited in this regard.

The calendar database 106 can store and retrieve calendar specific information. In particular, the calendar database 106 can store and retrieve calendar entries, including any of a variety of information that may be associated with the calendar entries. Such information can include, for example, an identification of a calendar event, information about the calendar event, information related to the time, day and/or date of the calendar event, identifiers of one or more calendar users who are to participate in the calendar event, identifiers of one or more calendar users who may not be participating in the calendar event but are otherwise interested parties, and/or any other desired information. As used herein, a calendar user is a human being, and hereinafter may be referred to simply as a “user.” As used herein, a calendar event is an event scheduled to take place in accordance with an electronic calendar entry (hereinafter “calendar entry”). The event can be a meeting, a teleconference, an action to be performed, or the like.

The project management database 108 can store and retrieve information related to projects, as well as related resource information. The resource information can include, for instance, information that identifies resources allocated to a project, dates and times related to the project (e.g., Gantt charts, due dates and deadlines), project goals, and so on.

The decision management database 110 can include decision information related to the project. This decision information can include historical information related to decisions that have been made (i.e., closed decisions) and information related to decisions that have not yet been made (i.e., open decisions). The decision information further can include information identifying owners of decisions and others who are involved in the decision making process, information related to intermediate results of open decisions, and information related to decision trends for the project. Any other information related to decisions and decision processes being applied to the project also can be included in the decision management database 110, and such information is within the scope of the inventive arrangements described herein.

In operation, the calendar management application 104 can retrieve from the calendar database 106 a calendar entry for a calendar event, as well as identify the subject of the calendar event and one or more calendar users that are associated with the calendar event. The calendar management application 104 also can query the project management database 108 to determine whether the identified subject is associated with a particular project. If so, the project management database 108 can identify the project, and the calendar management application 104 can query the decision management database 110 to determine whether the identified subject pertains to a decision to be made for the identified project.

If the identified subject pertains to a decision for the identified project, the calendar management application 104 further can query the decision management database 110 to identify an owner of the decision, identify decision makers and other people associated with the decision, identify the priority level of the decision, and identify any other pertinent information related to the decision. The calendar management application 104 can process this information to assign a priority level to the calendar entry.

In addition, the calendar management application 104 can associate the assigned priority level with the subject calendar entry and any other corresponding calendar entries. For example, the calendar management application 104 can update the priority information associated with the calendar entry/entries within the calendar database 106.

The calendar management application 104 also can relay priority information directly to any corresponding electronic calendaring applications using one or more suitable application program interfaces 112. By way of example, the calendar management application 104 can communicate one or more messages containing the priority information to applicable electronic calendaring applications. In another arrangement, the electronic calendaring applications can be configured to receive such information directly from the calendar database 106. For instance, the information can be provided to the calendaring applications when the calendaring applications are synchronized with the calendar database.

The calendar management application 104 can process the information received from the various databases 106-110 to determine whether there are calendaring conflicts among calendar users associated with the decision. Such calendared users can include a decision owner, decision makers and/or the other people associated with the decision. For instance, based on the calendar users identified by the decision management database 110 as being associated with the decision, the calendar management application 104 can access the calendar database 106 to determine whether any of those calendar users have a calendaring conflict with the subject calendar entry.

If the calendar management application 104 identifies any calendaring conflicts, the calendar management application 104 can implement any of a myriad of suitable actions to resolve the conflicts. For example, if a particular calendar user is a decision making participant scheduled to participate in making the decision (e.g., a decision owner, a decision maker or another person associated with the decision), and that calendar user has a calendaring conflict, the calendar management application 104 can identify and compare the respective priority levels of the calendar events that are in conflict, and automatically change the calendar entry for the calendar event having the lower priority.

The priority levels of the respective calendar events can be determined in any suitable manner. In one arrangement, as noted, the calendar events can correspond to respective decisions. The decisions can be hierarchically organized, as will be described herein. Further, the priority levels can be determined, at least in part, based on an identification of the respective positions of the decisions in the decision hierarchy. For example, a decision that is higher in the decision hierarchy can be assigned a greater priority level than a decision that is lower in the decision hierarchy. Accordingly, the priority level determined for the decision that is higher in the decision hierarchy can be greater than a priority level for the decision that is lower in the decision hierarchy.

In another arrangement, the priority levels can be determined, at least in part, based on projects with which the respective decisions are associated. For example, the priority level of each decision can correspond to the priority level assigned to the respective projects with which the decisions are associated. Thus, if a first project is assigned a higher priority than a second project, decisions associated with the first project can be assigned a higher priority level than decisions associated with the second project.

In yet another arrangement, the priority levels assigned to decisions can be determined both by the projects with which they are associated and their positions within the respective decision hierarchies. For instance, a project priority level can be assigned to the project with which a decision is associated and a position based priority level can be assigned to a level in the decision hierarchy at which the decision is located. The priority level that is assigned to the decision then can be determined by summing the project priority level and the position priority level. Alternatively, the priority level that is assigned can be determined by multiplying the project priority level and the position priority level.

In yet another arrangement, the priority levels assigned to decisions can be determined by the monetary value of the decisions to be made. Monetary value may be projected earnings, capital funds to be spent, monetary value of payroll that will be affected by the decision, etc.

The calendar entry to be changed can be changed in any suitable manner. For instance, in one aspect of the inventive arrangements, the calendar management application 104 can access the decision management database 110 to determine whether there is another calendar user who is identified as being a suitable candidate to be a substitute decision making participant for the person having the calendaring conflict. Hereinafter, a substitute decision making participant may be referred to as a “substitute participant.”

If a substitute participant is identified, the calendar management application 104 can generate a corresponding calendar entry for the substitute participant. For instance, the calendar management application 104 can update the substitute participant's calendaring information contained in the calendar database 106 or communicate a calendar entry to the substitute participant's electronic calendaring application via the API 112. The calendar management application 104 then can update the original calendar entry to indicate that the substitute participant is scheduled to participate in the decision making process in lieu of the original decision making participant being replaced. The original calendar entry also can be updated with other information, for instance an indication why the substitute participant has been selected. One or more other corresponding calendar entries, for instance calendar entries for other decision making participants, also can be updated to indicate these changes.

The electronic calendaring application of the substitute participant and the other decision making participants can be identified by information contained in the calendar database 106, the project management database 108 and/or the decision management database 110, each of which can be accessed by the calendar management application 104 as necessary. In addition, the calendar management application 104 also can update one or more of the databases 106-110 to indicate that a participant substitution is being made, as well as any other desired information.

In another arrangement, rather than identifying a substitute participant for the calendar event, the calendar management application 104 can identify a substitute decision that may be made in lieu of the decision originally corresponding to the calendar entry (hereinafter the “original decision”). As used herein, a “substitute decision” is a decision that can be made in lieu of an original decision when a decision making participant is not available, and the remaining decision making participants match up with a minimum set of decision making participants needed for this decision. For example, a meeting may be scheduled to decide on an expansion project in a factory. If a key decision making participant (e.g., representative from facilities) does not attend the meeting, this could prevent a decision from being made. However, if the attending members represent all required parties to make a decision (e.g., on an incentive package for the staff), the calendar function can update information associated with the meeting and notify all attending participants that a decision can be reached without the decision maker who failed to attend the meeting.

The calendar management application 104 then can update the original calendar entry to indicate that the substitute decision is to be made in lieu of the original decision. One or more other corresponding calendar entries for the decision making participants also can be updated to indicate that the substitute decision is to be made in lieu of the original decision for this calendar event. Other information, for instance, an indication why the substitute decision is to be made, also can be updated to the original calendar entry and/or the other calendar entries. The calendar entries can be updated as previously described. In addition, the calendar management application 104 also can update one or more of the databases 106-110 to indicate that the substitute decision is to be made, as well as any other desired information.

In yet another arrangement, the calendar management application 104 can automatically reschedule the calendar event. In illustration, the calendar management application 104 can analyze calendar entries for the various decision making participants and automatically select a new time, day and/or date on which to move the calendar event. If, however, a suitable new time, day and/or date is not identified, the calendar management application 104 can cancel the calendar event. When a calendar event is rescheduled or canceled, corresponding calendar entries can be updated, canceled and/or generated to reflect the rescheduling or cancelation. Other information, for instance the reason for canceling or rescheduling the calendar event, also can be indicated. In addition, one or more of the databases 106-110 can be updated with information relevant to the calendar event rescheduling or cancelation. For decision making calendar events that are canceled, the calendar management application 104, and/or one or more of the databases 106-110, can maintain a list of calendar events that needed to be rescheduled. Optionally, the calendar management application 104 can send notifications to calendar users identified in the project management database 108 or the decision management database 110 as being responsible or dependent on the decisions that were scheduled to be made.

In some instances a decision may be arrived at prior to a scheduled meeting for making the decision. If a decision is entered in the decision management database, the calendar management application 104 may check to determine whether time is left in the meeting. If time is left, the calendar management application 104 may search the project management database 108 and/or the decision management database 110 to identify other outstanding decision(s) that require no more than a subset of those persons actually attending the meeting and offer these decisions to those attending the meeting as possible work items for the allocated time remaining in the meeting.

To further facilitate managing calendar events pertaining to decisions that are to be made, the CMS 100 can include or can be communicatively linked to a decision management system 114 that manages a decision network. The decision management system 114 can be implemented as a component of the calendar management application 104 or as another application communicatively linked to the decision management database 114.

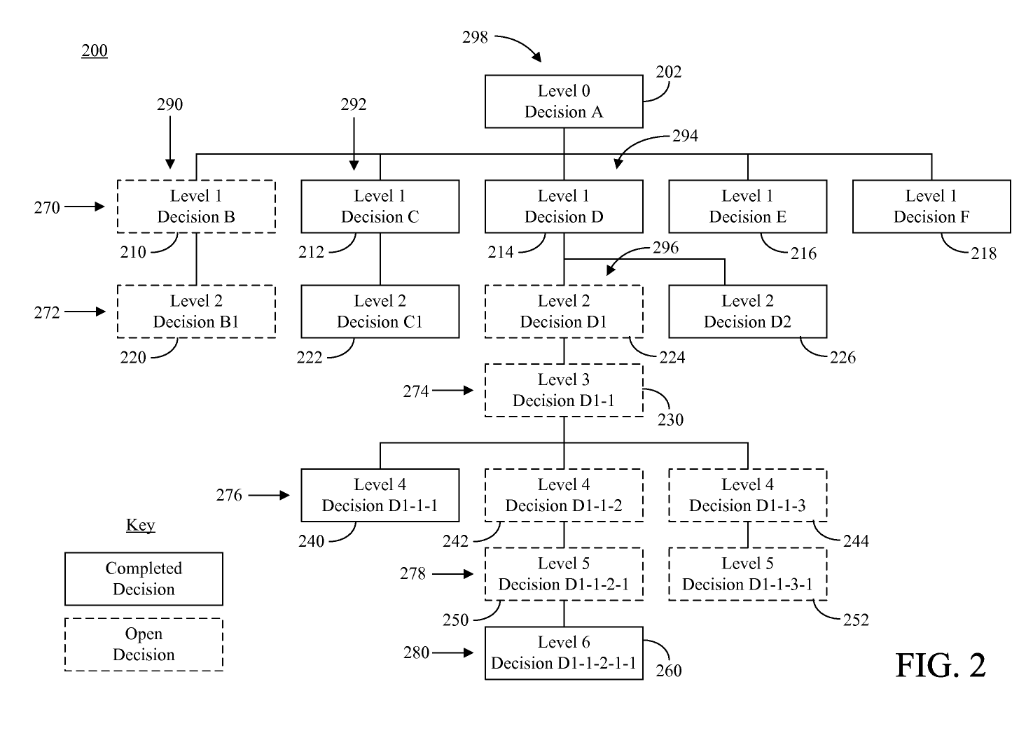

FIG. 2 depicts an example of a decision network 200 that is useful for understanding the present invention. The decision network 200 can include a plurality of decisions 202, 210, 212, 214, 216, 218, 220, 222, 224, 226, 230, 240, 242, 244, 250, 252, 260, each of which is represented as a block in the decision network 200. The decisions 202-260 are loosely coupled, but logically related in a hierarchical manner. For the purposes of illustration, completed decisions 202, 212-218, 222, 226, 240 are depicted in the decision network 200 as blocks which have a solid border, while decisions 210, 220, 224, 230, 242-252 not yet completed (i.e. open decisions) are depicted as blocks with a dashed border. The significance of completed decisions and open decisions will be discussed herein in further detail.

Each decision 202-260 within the decision network 200 can be modeled and analyzed using any suitable decision analysis methodology (e.g. influence diagrams, decision trees, multi-criteria decision-making, such as the Kepner-Tregoe decision-making method or analytical hierarchy process (AHP), and so on). In one arrangement, a common decision analysis method can be applied to make each of the decisions 202-260. In another arrangement, the decision analysis applied to each decision 202-260 can be selected based on the type of decision to be made (e.g. technology selection, financial, strategy, etc.).

The decisions 202-260 can be represented in the decision network 200 by a decision hierarchy in which a number of decision groups are defined. As used herein, the term “decision group” means a group of two or more decisions wherein a single decision is at a decision level that is higher than the decision levels of any other decisions in that decision group. In other words, a decision group comprises a primary decision at the highest decision level within the decision group, and one or more associated subordinate decisions that are at lower decision levels in the decision network 200 than the decision level of the primary decision. That said, a decision which is a subordinate decision in a first decision group may be a primary decision in another decision group.

In illustration, the decision 210 can be associated with a decision 220 that is at a lower decision level 272 within the decision network 200 than the decision level 270 at which the decision 210 is located. Hence, the decisions 210, 220 can be considered a decision group 290, with the decision 210 being the primary decision and the decision 220 being a subordinate decision. Similarly, the decisions 212, 222 can be considered a decision group 292 with the decision 212 being the primary decision and the decision 222 being a subordinate decision. The decision 214 is associated with decisions 224-260, so all such decisions can be considered a decision group 294 in which the decision 214 is the primary decision and the decisions 224-260 are subordinate decisions.

Further, decisions 224, 230, 240-244, 250-252 and 260 can be considered a decision group 296 in which the decision 224 is the primary decision and the other decisions 230, 240-244, 250-252 and 260 are subordinate decisions. However, the decision 224 can be a subordinate decision in the decision group 294. Accordingly, the decision group 296 can be referred to as a sub-group of the decision group 294. Likewise, the decision groups 290-294 each can be considered sub-groups of the decision group 298 that includes all of the decisions 202-260. In this decision group 298, the target decision 202 is the primary decision and the decisions 210-260 are subordinate decisions.

At this point it should be noted that decision groups can be defined by any other logical relationships. Indeed, the decisions 202-260 need not all be in the same decision network or decision hierarchy. For example, if a company wishes to decide whether to manufacture a particular product, the decision network 200 may include all the decisions 202-260 for defining and manufacturing the product. In another arrangement, decisions 214, 224-260 for defining the product may be defined in a first decision network or hierarchy, and decisions 212, 222 for determining where to manufacture the product may be defined in a second decision network or hierarchy. Still, the decisions 202-260 can be arranged in any other suitable decision network(s) or decision hierarchy/hierarchies, and the invention is not limited in this regard.

The primary decision in a decision group typically limits the scope of subordinate decisions in the decision group, though this need not be the case. For instance, a decision 214 of a decision group 294 can limit the scope of the decisions 224, 230, 240, 242, 244, 250, 252, 260. In illustration, if the decision 214 pertains to a determination of whether to pursue a new product line, the decisions 224-260 can be limited to decisions that are narrower in scope, but still related to the new product line. For instance, the decision 226 can pertain to the marketing strategy for the new product line.

Various types of decision groups may be implemented in accordance with the inventive arrangements. For example, a primary decision and one or more subordinate decisions on which the primary decision is based, at least in part, may be referred to as a rollup decision group. In addition to subordinate decisions, other factors (not shown) also may influence primary decisions in a rollup decision group. In other words, although a primary decision in a rollup decision group may be based on one or more subordinate decisions, the subordinate decisions need not necessarily bind the higher level decision to a particular determination.

In the present example, a target decision 202 to be made can be identified as “level 0, decision A” in the decision network 200, and can be based on any number of subordinate decisions. For instance, the target decision 202 can be based on a plurality of decisions 210, 212, 214, 216, 218 which are made at the first decision level 270 that is subordinate to the decision 202. Further, the decisions 210-218 can be based on other subordinate decisions 220, 222, 224, 226 at the second decision level 272, and so on. Nonetheless, one or more of these decisions can be based on other decisions lower in the decision hierarchy. For example, the decision 210 can be based on a decision 220 at the second decision level 272 of the decision hierarchy. Similarly, the decisions 212 can be based on a decision 222 at the second decision level 272 of the decision hierarchy. In contrast to the decisions 220, 222, the decision 214 can be based on a plurality of decisions, namely decision 224 and a decision 226, both of which are at the second decision level 272.

Continuing further, the decision 224 can be based on a decision 230 at the third level 274 of the decision hierarchy, and the decision 230 can be based on the decisions 240, 242, 244 at the fourth level 276. The decision 242 can be based on the decision 250 at the fifth level 278, and the decision 244 can be based on the decision 252. Finally, the decision 250 can be based on the decision 260 at the sixth decision level 280. Notwithstanding this example, any number of decisions and any number of decision levels may be implemented and the invention is not limited in this regard. Moreover, a decision that is a primary decision in one decision group can be a subordinate decision in one or more other decision groups.

In contrast to a rollup decision group, a constrained decision group comprises a primary decision and one or more subordinate decisions that are constrained by the primary decision. In a constrained decision group, for example the decision group 294, the primary decision 214 can constrain subordinate decisions 224-260 made at various decision levels 272, 274, 276, 278, 280 which are lower than the decision level 270 of the primary decision 214 in the decision network 200. In other words, the decisions 224-260 can be made after the primary decision 214 has been made, and the scope of the decisions 224-260 can be based on the result of the primary decision 214.

Information related to the primary decision 214 also can be provided to owners associated with the decisions 224-260 to guide such owners in their respective decision processes. As used herein, the term “owner” means a person who is tasked with managing the decision processes for a decision in order to make the decision or a person who is accountable for the outcome of the decision.

In a constrained decision group, a primary decision 214 can provide information to owners of subordinate decisions 224-260 through a set of constraints that are automatically associated with the subordinate decisions 224-260. In a rollup decision group, information related to subordinate decisions 224-260 can be provided to the owner of the primary decision 214 as a set of intermediate choices that may be used by the owner of the primary decision 214 to complete the primary decision 214. In this regard, the intermediate choices can be automatically associated with the primary decision 214 when the intermediate choices are made.

In any of these cases, the constraints and/or choices can be associated with the appropriate decisions 202-260 at the time the decisions are completed 200, after the decisions have been reviewed and approved, or at any other time that is deemed suitable. In one example, the constraints and/or intermediate choices can be communicated to other suitable decision owners via email. In another example, the constraints and/or intermediate choices can be entered into an application tasked with managing the decision process. In addition to tracking decision goals, the application can define which subordinate decisions need to be made and in which order such decisions need to be made. In addition, reminders can be sent to decision owners of upcoming deadlines. Further, once decisions are made and entered into the application, the application can generate reminders to other relevant decision owners as to the status of various decisions and/or actions that are necessary to continue the decision process. The application also can maintain relationships between this information to further enhance the maintainability of the decision network(s) 200.

By way of example, if the target decision 202 relates to developing a product for a new market segment, the decision 210 can relate to the target list price of the product, and the decision 220 can relate to the target manufacturing cost of the product. The target decision 202 whether to develop the product can be made first. Then, the decision 210 relating to the target list price of the product can be made. Once the decision 210 has been made, the information related to the target list price can be conveyed to the owner of the decision 220 and used to constrain the scope of the decision 220. For instance, if the target list price selected by the decision 210 is one hundred dollars, the target manufacturing cost selected by the decision 220 can be equal to or less than forty dollars.

Having described both rollup decision groups and constrained decision groups, it will be appreciated by one skilled in the art that the inventive arrangements can implement one or more rollup decision groups and/or one or more constrained decision groups. In this regard, the term “decision group,” as used herein, may refer to a rollup decision group and/or refer to a constrained decision group.

For any particular decision group 290, 292, 294, 296, the costs associated with the entire decision group can correspond to the summation of costs associated with each of the decisions within that particular decision group 290, 292, 294, 296. For instance, the cost associated with the decision group 290 can correspond to a summation of costs associated with the decisions 210, 220. Similarly, the costs associated with the decision group 292 can correspond to the summation of costs associated with the decisions 212, 222, and so on.

The decision 224 can pertain to the fixed overhead resources to allocate to the new product line, while the decision 230 can pertain to facilities that may be required. Since the size of a facility that is required generally depends on the staffing levels that will be required, the manufacturing space that will be needed, and the amount of administrative space that will be required, etc., the decision 240 can pertain to the staff that will be needed to support the product line, the decision 242 can pertain to the manufacturing equipment that will be needed to produce the products, and decision 244 can pertain to the office space that will be needed, and so on.

In one arrangement, the various decisions 202, 210-260 in the decision network 200 can be entered and maintained in the decision management database or another suitable data management structure. The decisions 202, 210-260 can be entered into the decision management database by a user using a suitable user interface, or by an application configured to enter such decisions into the decision management database.

It should be noted that, in some cases, the priority of a decision may be independent of its position in the decision network. For example, if it is foreseen that one or more decisions 240-260 at the bottom of the decision network 200 have higher priority and/or cost impact than one or more other decisions 220, 222, 226 near the top of the decision network 200, these decisions 240-260 can be assigned higher priority in the decision network 200 that the decisions 220, 222, 226.

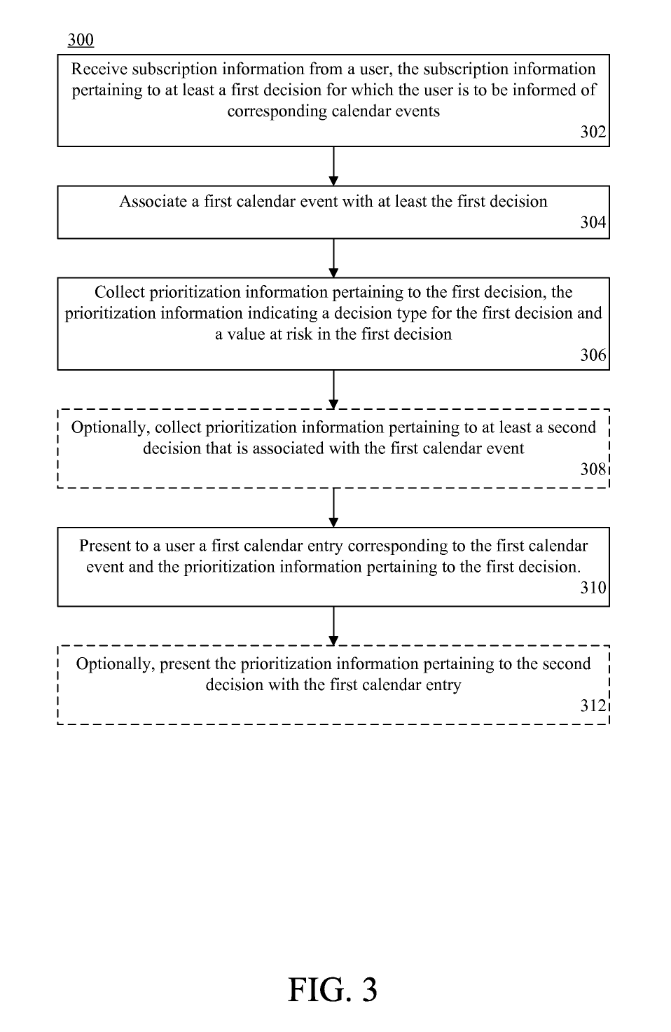

FIG. 3 is a flowchart presenting a method 300 of managing an electronic calendar that is useful for understanding the present invention. At step 302, subscription information can be received from a user. The subscription information can pertain to at least a first decision for which the user is to be informed of corresponding calendar events. For example, if the user is a decision owner, or otherwise interested in, or involved with, various decisions that are to be made, the user can subscribe to be informed of calendar events for such decisions. The calendar events can be presently scheduled events and/or future calendar events that are not yet scheduled. Alternately, a user may subscribe to be informed of the decisions made at the event or to be informed if the meeting is delayed or rescheduled. This would be useful for users interested in the decision itself but who do not need to attend the meeting.

At step 304, a first calendar event can be associated with the first decision. Other calendar events can be associated with other decisions as well. For example, when a calendar event is created, one or more decisions to which the calendar event pertains can be entered into the calendar management application via the user interface, and those decisions can be associated with the calendar event. Alternatively, the calendar management system can communicate with the decision management database to receive a list of decisions, and such list can be presented to the user via the user interface. From that menu the user can select the decision(s) that are to be associated with the calendar entry. The calendar entry and the associated decision(s), or suitable link(s) to the decision(s), can be stored in the calendar database.

At step 306, prioritization information pertaining to a first decision can be collected. The prioritization information can indicate a decision type for the first decision and a value at risk in the first decision. The prioritization information also can indicate a priority level assigned to the first decision. Optionally, for example when there are a plurality of decisions associated with a calendar event, at step 308 prioritization information pertaining to at least a second decision can be associated with the calendar event. The calendar management application can retrieve the prioritization information from the decision management database, or from another suitable data source. The prioritization information, or links to the prioritization information, can be stored in the calendar database.

At step 310, a first calendar entry corresponding to the first and/or second calendar event can be presented to the user. For example, the calendar management application can present the calendar entry to the user in an electronic calendar that is presented to the user via the user interface. In one arrangement, the calendar entry can be presented in a color-coded form. The color-coded form can indicate a priority level assigned to the first decision. For example, calendar entries associated with high priority decisions can be presented in red, calendar entries associated with medium priority decisions can be presented in orange, and calendar entries associated with low priority decisions can be presented in yellow. In another arrangement, the color-coded form can indicate a decision or a decision network with which the decision is associated. For example, a first decision or decision network can be assigned a first color, a decision or decision network can be assigned a different color, and so on.

Optionally, at step 312, the prioritization information pertaining to the second decision can be presented with the first calendar entry. In one arrangement, the prioritization information can be presented when the user opens the calendar entry, but the prioritization information can be presented in any other suitable manner and the invention is not limited in this regard.

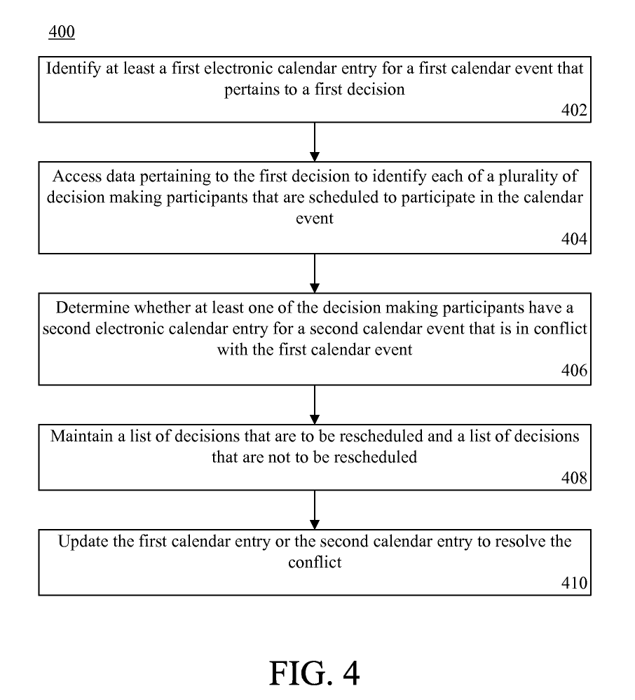

FIG. 4 is another flowchart presenting a method 400 of managing an electronic calendar that is useful for understanding the present invention. At step 402, at least a first calendar entry for a first calendar event that pertains to a first decision can be identified. A first priority level of the first calendar event and a second priority level of the second calendar event can be determined In addition, which of the first priority level and the second priority level is lower also can be determined

At step 404, data pertaining to the first decision can be accessed to identify each of a plurality of decision making participants that are scheduled to participate in the calendar event. At step 406, a determination can be made as to whether at least one of the decision making participants have a second calendar entry for a second calendar event that is in conflict with the first calendar event. Identifying the first priority level can include identifying a position of the first decision in a decision hierarchy and determining the first priority level based on the position of the first decision in the decision hierarchy.

For example, priority levels for projects with which the first decision and second decisions are respectively associated can be identified, and the priority levels can be determined based on the respective project priority levels. In another arrangement, the priority levels of the projects with which the respective decisions are associated can be determined. The positions of the decisions in respective decision hierarchies also can be determined The priority levels of the projects and the position of the respective decisions can be determined and evaluated to determine their priority levels with respect to one another.

At step 408, one or more lists of decisions can be maintained. The lists of decision can include those decisions that are to be rescheduled, and those decisions that are not to be rescheduled.

At step 410, the first calendar entry or the second calendar entry can be updated to resolve the conflict. In one arrangement, updating the first calendar entry or the second calendar entry to resolve the conflict can include selecting a substitute decision making participant to participate in making the decision. When the first priority level is lower than the second priority level, updating the calendar entry can include changing the first calendar entry. When the second priority level is lower than the first priority level, updating the calendar entry can include changing the second calendar entry.

In one arrangement, updating the first calendar entry or the second calendar entry also can include updating at least the first calendar entry or the second calendar entry to indicate that the substitute decision making participant has been selected to participate in making the first decision in lieu of the decision making participant having the second calendar entry that is in conflict with the first calendar entry. Updating the first calendar entry or the second calendar entry to resolve the conflict also can include selecting a substitute decision to be made in lieu of the first decision, and updating at least the first calendar entry or the second calendar entry to indicate that the substitute decision is to be made in lieu of the first decision.

In another arrangement, changing the first calendar entry or the second calendar entry to resolve the conflict can include rescheduling the calendar event, and dating at least the first calendar entry or the second calendar entry to indicate that the calendar event has been rescheduled. The calendar event also can be canceled, and the first calendar entry and/or the second calendar entry can be updated to indicate that the calendar event has been canceled.

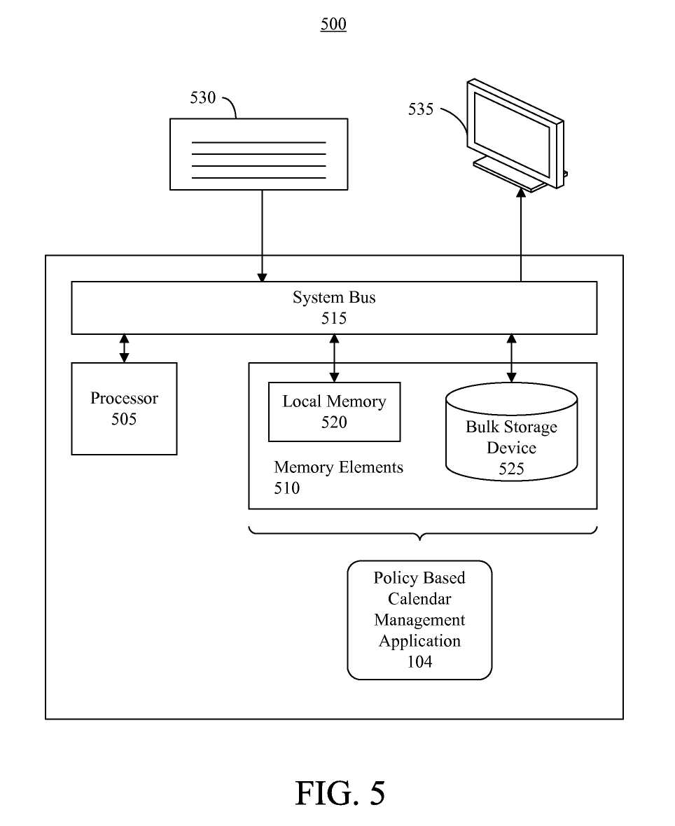

FIG. 5 is a block diagram illustrating an electronic system 500 that is useful for understanding the present invention. The electronic system 500 can be implemented as a computer (e.g., a server, a personal computer, a mobile computer (e.g., a laptop computer, a netbook, or the like), a mobile telephone (e.g., a cellular telephone, a smartphone, etc.), a personal digital assistant, a mobile terminal, an application specific device, or any other electronic device(s) that is configured to execute program code in accordance with methods and processes described herein. In one arrangement, the electronic system 500 can include a plurality of computers and/or other devices. For instance, the electronic system 500 can include one or more computers that are servers, one or more computers that are clients, one or more mobile telephones, one or more personal digital assistants and/or one or more terminals.

The electronic system 500 can include at least one processor 505 coupled to a data storage medium, such as memory elements 510, through a system bus 515. As such, the electronic system 500 can store computer-usable program code within the memory elements 510. The processor 505 can execute computer-usable program code accessed from the memory elements 510 via the system bus 515. In one arrangement, for example, the electronic system 500 can be implemented as a computer that is suitable for storing and/or executing program code. It should be appreciated, however, that the electronic system 500 can be implemented in the form of any system comprising a processor and data storage medium that is capable of performing the functions described within this specification. Moreover, when the electronic system 500 includes more than one device (e.g., computer, mobile telephone, etc.), each device may include the various components 505-515 described herein.

The memory elements 510 can include one or more physical memory devices such as, for example, local memory 520 and one or more bulk storage devices 525. Local memory 520 refers to random access memory or other non-persistent memory device(s) generally used during actual execution of the program code. The bulk storage device(s) 525 can be implemented as a hard drive or other persistent data storage device. The electronic system 500 also can include one or more cache memories (not shown) that provide temporary storage of at least some program code in order to reduce the number of times program code must be retrieved from the bulk storage device 525 during execution. Optionally, sections of the Bulk storage 525 can be located on a remote server and accessed by the electronic system 500 over a wired or wireless connection.

Input/output (I/O) devices such as a keyboard 530, a display 535, and a pointing device (not shown) optionally can be coupled to electronic system 500 as components of a user interface. Other I/O devices that may be coupled to the electronic system 500 may include, but are not limited to, buttons, keypads, soft-keys, touch screens, audio output devices, audio input devices, voice recognition devices, and so on. The I/O devices can be coupled to the electronic system either directly or through intervening I/O controllers, network adapters, or the like. Indeed, the electronic system 500 can include a plurality of user interfaces, each of which may be directly connected to a respective client or terminal

The network adapters can be coupled to the electronic system 500 to enable various components of the electronic system 500 to communicate with one another. For example, clients can communicate with servers via the network adapters. Modems, cable modems, Ethernet cards and RF transceivers are examples of different types of network adapters that can be used with the electronic system 500.

As pictured in FIG. 5, the memory elements 510 can store the calendar management application 104. The calendar management application 104, being implemented in the form of executable program code, can be executed by the processor 505 to implement the methods and processes described herein. The calendar database, project management database, decision management database depicted in FIG. 1 also can be stored in the memory elements 510, or can be accessed on other electronic systems that are communicatively linked to the electronic system 500.

Accordingly, the present invention can be realized in hardware or a combination of hardware and software. The present invention can be realized in a centralized fashion in one electronic system configured to perform processing on software and/or data, or in a distributed fashion where different elements are spread across several interconnected processing systems. Any kind of processing system or other apparatus adapted for carrying out the methods described herein is suited. A typical combination of hardware and software can be an electronic system with one or more processors and computer-usable program code that, when being loaded and executed, controls the electronic system such that it carries out the methods described herein.

The present invention also can be embedded in a computer-usable medium, such as a computer program product or other data programs storage device, readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The flowcharts and block diagram in the figures illustrate the architecture, functionality, and operation of possible implementations of systems, methods and computer program products according to various embodiments of the present invention. In this regard, each block in the flowcharts or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

As used herein, the term decision group means a group of one or more logically related decisions. The terms “computer program,” “software,” “application,” variants and/or combinations thereof, in the present context, mean any expression, in any language, code or notation, of a set of instructions intended to cause an electronic system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a gadget, a widget, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of managing an electronic calendar, comprising:
in a calendar management system linked to a decision management system, associating a first calendar event with at least a first decision;
in the calendar management system, collecting prioritization information pertaining to the first decision, the prioritization information indicating a decision type for the first decision and a value at risk in the first decision;
via a display of an electronic system, presenting to a user a first calendar entry corresponding to the first calendar event and the prioritization information pertaining to the first decision.

2. The method of claim 1, further comprising:
in the calendar management system, collecting prioritization information pertaining to at least a second decision that is associated with the first calendar event; and
presenting the prioritization information pertaining to the second decision with the first calendar entry corresponding to the first calendar event.

3. The method of claim 1, further comprising:
via a user interface coupled to the electronic system, receiving subscription information pertaining to at least the first decision;
when a future calendar event that is associated with the first decision is scheduled, in the calendar management system collecting prioritization information pertaining to the future calendar event; and
presenting the prioritization information pertaining to the future calendar event to the user via a display of the electronic system.

4. The method of claim 1, wherein:
the prioritization information further indicates a priority level assigned to the first decision; and
presenting to the user the first calendar entry corresponding to the first calendar event and the prioritization information pertaining to the first decision comprises presenting the first calendar entry in a color-coded form, the color-coded form indicating the priority level assigned to the first decision.

5. The method of claim 1, wherein presenting to the user the first calendar entry corresponding to the first calendar event and the prioritization information pertaining to the first decision comprises:
presenting the first calendar entry in a color-coded form, the color-coded form indicating a decision or a decision network with which the first decision is associated.

6. The method of claim 1, further comprising:
with the electronic system, accessing data pertaining to the first decision to identify each of a plurality of decision making participants that are scheduled to participate in the first calendar event;
with the electronic system, determining whether at least one of the decision making participants have a second calendar entry for a second calendar event that is in conflict with the first calendar event;
with the electronic system, selecting a substitute decision making participant to participate in making the first decision; and
with the electronic system, updating the first calendar entry to indicate that the substitute decision making participant has been selected to participate in making the first decision in lieu of the decision making participant who has the second calendar entry that is in conflict with the first calendar entry.

7. The method of claim 1, further comprising:
with the electronic system, accessing data pertaining to the first decision to identify each of a plurality of decision making participants that are scheduled to participate in the first calendar event;
with the electronic system, determining whether at least one of the decision making participants have a second calendar entry for a second calendar event that is in conflict with the first calendar event;
when there is a conflict with the first calendar event, determining whether the first decision can be made without the participation of the decision making participant who has the second calendar event that is in conflict with the first calendar event;
when the first decision cannot be made without the participation of the decision making participant who has the second calendar event that is in conflict with the first calendar event, with the electronic system selecting a substitute decision to be made in lieu of the first decision; and
with the electronic system, updating the first calendar entry to indicate that the substitute decision is to be made in lieu of the first decision.

8. The method of claim 7, further comprising:
with the electronic system, maintaining a list of decisions that are to be rescheduled and a list of decisions that are not to be rescheduled; and
determining that the first decision is not contained on the list of decisions that are not to be rescheduled.

9. The method of claim 1, further comprising:
determining by the electronic system a first priority level of the first calendar event;
determining by the electronic system a second priority level of a second calendar event that is conflicting with the first calendar event; and
determining by the electronic system which of the first priority level and the second priority level is lower;
with the electronic system changing the first calendar entry to resolve the conflict when the first priority level is lower than the second priority level; and
with the electronic system changing the second calendar entry to resolve the conflict when the second priority level is lower than the first priority level.

10. The method of claim 9, wherein identifying the first priority level of the first calendar event comprises:
with the electronic system identifying a position of the first decision in a decision hierarchy; and
determining by the electronic system the first priority level based on the position of the first decision in the decision hierarchy.

11. The method of claim 9, wherein identifying the first priority level of the first calendar event comprises:
with the electronic system identifying a project priority level for a project with which the first decision is associated; and
determining by the electronic system the first priority level based on the project priority level.

12. The method of claim 9, wherein identifying the first priority level of the first calendar event comprises:
with the electronic system identifying a project priority level for a project with which the first decision is associated;
with the electronic system identifying a position of the first decision in a decision hierarchy; and
determining by the electronic system the first priority level based on the project and the position of the first decision in the decision hierarchy.

13. A computer program product comprising:
a data storage medium comprising computer-usable program code that manages an electronic calendar, the data storage medium comprising:
computer-usable program code that, in a calendar management system linked to a decision management system, associates a first calendar event with at least a first decision;
computer-usable program code, in the calendar management system, collects prioritization information pertaining to the first decision, the prioritization information indicating a decision type for the first decision and a value at risk in the first decision;
computer-usable program code that presents to a user a first calendar entry corresponding to the first calendar event and the prioritization information pertaining to the first decision via a display of an electronic system.

14. The computer program product of claim 13, wherein the computer-usable program code further comprises:
computer-usable program code that, in the calendar management system, collects prioritization information pertaining to at least a second decision that is associated with the first calendar event; and
computer-usable program code that presents the prioritization information pertaining to the second decision with the first calendar entry corresponding to the first calendar event.

15. The computer program product of claim 13, wherein the computer-usable program code further comprises:
computer-usable program code that receives via a user interface coupled to the electronic system subscription information pertaining to at least the first decision;
computer-usable program code that, when a future calendar event that is associated with the first decision is scheduled, collects in the calendar management system prioritization information pertaining to the future calendar event; and
computer-usable program code that presents the prioritization information pertaining to the future calendar event to the user via a display of the electronic system.

16. The computer program product of claim 13, wherein:
the prioritization information further indicates a priority level assigned to the first decision; and
the computer-usable program code that presents to the user the first calendar entry corresponding to the first calendar event and the prioritization information pertaining to the first decision further comprises:
computer-usable program code that presents the first calendar entry in a color-coded form, the color-coded form indicating the priority level assigned to the first decision.

17. The computer program product of claim 13, wherein the computer-usable program code that presents to the user the first calendar entry corresponding to the first calendar event and the prioritization information pertaining to the first decision via a display of an electronic system further comprises:
computer-usable program code that presents the first calendar entry in a color-coded form, the color-coded form indicating a decision or a decision network with which the first decision is associated.

18. The computer program product of claim 13, wherein the computer-usable program code further comprises:
computer-usable program code that, with the electronic system, accesses data pertaining to the first decision to identify each of a plurality of decision making participants that are scheduled to participate in the first calendar event;
computer-usable program code that, with the electronic system, determines whether at least one of the decision making participants have a second calendar entry for a second calendar event that is in conflict with the first calendar event;
computer-usable program code that, with the electronic system, selects a substitute decision making participant to participate in making the first decision; and
computer-usable program code that, with the electronic system, updates the first calendar entry to indicate that the substitute decision making participant has been selected to participate in making the first decision in lieu of the decision making participant who has the second calendar entry that is in conflict with the first calendar entry.

19. The computer program product of claim 13, wherein the computer-usable program code further comprises:
computer-usable program code that, with the electronic system, accesses data pertaining to the first decision to identify each of a plurality of decision making participants that are scheduled to participate in the first calendar event;
computer-usable program code that, with the electronic system, determines whether at least one of the decision making participants have a second calendar entry for a second calendar event that is in conflict with the first calendar event;
computer-usable program code that, when there is a conflict with the first calendar event, determines whether the first decision can be made without the participation of the decision making participant who has the second calendar event that is in conflict with the first calendar event;
computer-usable program code that, when the first decision cannot be made without the participation of the decision making participant who has the second calendar event that is in conflict with the first calendar event, with the electronic system, selects a substitute decision to be made in lieu of the first decision; and
computer-usable program code that, with the electronic system, updates the first calendar entry to indicate that the substitute decision is to be made in lieu of the first decision.

20. The computer program product of claim 13, wherein the computer-usable program code further comprises:
computer-usable program code that, with the electronic system, maintains a list of decisions that are to be rescheduled and a list of decisions that are not to be rescheduled; and
computer-usable program code that determines that the first decision is not contained on the list of decisions that are not to be rescheduled.
